(19) United States
(12) Patent Application Publication
(10) Pub. No.: US 2007/0065085 A1
(43) Pub. Date: Mar. 22, 2007

(54) Assembly of a protection cover and a circuit board

(76) Inventors: Danny Louis Cornelius Morlion, Gent (BE); Jan Peter Karel Van Koetsem, Bazel (BE); Hendrikus Petrus Gijsbertus Van Der Steen, Noordt Brabant (NL)

Correspondence Address: HARRINGTON & SMITH, LLP, 4 RESEARCH DRIVE, SHELTON, CT, 06484-6212, US

(21) Appl. No.: 10/554,089

(22) PCT Filed: Apr. 7, 2004
(86) PCT No.: PCT/EP04/50469

§ 371 Date: Oct. 10, 2006

(30) Foreign Application Priority Data
Apr. 28, 2003 (NL) 1023290

(51) Int. Cl. G02B 6/00

(52) U.S. Cl. 385/134

(57) ABSTRACT

The invention relates to an assembly of a protection cover and a circuit board including one or more optical conductors. The optical conductors are embedded in said circuit board, said circuit board including an optical cavity exposing at least a part of said embedded optical conductors and said protection cover is adapted to use said optical cavity as a reference. The invention further relates to a protection cover and a circuit board for use in the assembly.

The invention relates to an assembly of a protection cover and a circuit board comprising one or more optical conductors.

EP 0 729 045 discloses a protection cover for an alignment piece for optical conductors to seal reference faces and optical contact pads from the environment during processing. The cover is removed after completing the printed circuit board (PCB).

A problem associated with the prior art is that after processing of the PCB, the protection cover no longer isolates the optical device from the environment.

It is an object of the invention to provide a protection cover that can be used during and after processing.

This object is achieved by providing an assembly of a protection cover and a circuit board characterized in that said optical conductors are embedded in said circuit board, said circuit board comprising an optical cavity exposing at least a part of said optical conductors and said protection cover is adapted to use said optical cavity as a reference.

In such an assembly the protection cover can be maintained until the optical conductors need to be accessed by e.g. an optical connector. Further, by using the walls determining the optical cavity as a reference, the protection cover no longer needs an alignment piece for positioning. The optical cavity thus is used both for accessing the optical signals of the embedded optical conductors though the optical window defined by the optical cavity and as a reference for positioning the protection cover. The optical conductors within the optical cavity can be protected by the protection cover from environmental influences during processing of the circuit board as well as during and/or after installation of the circuit board in the field.

In a preferred embodiment of the invention the protection cover comprises attachment means for joining said protection cover and said circuit board at said optical cavity. The attachment means may e.g. be mechanical attachment means. Such a mechanical attachment means is e.g. a mechanical latch and/or grip adapted to cooperate with the optical cavity or with the walls thereof. These walls may comprise holding features for the attachment means. Alternatively or in addition the mechanical attachment means may cooperate with an additional frame provided in the optical cavity. This attachment means prevents the protection cover to be removed accidentally or unintentionally during processing or during or after installation in the field.

In an embodiment of the invention the optical cavity in the circuit board is adapted to accommodate a mounting frame comprising holding features and said attachment means are adapted to engage with said holding features. In this embodiment the optical cavity thus acts as an indirect reference for positioning of the protection cover. The mounting frame preferably comprises fastening means for fixating the mounting frame within said optical cavity. These fastening means may comprise one or more barbs securing the mounting frame within the optical cavity in order to ensure that the thus positioned frame is and remains an appropriate reference for the protection cover. The attachment means preferably comprises a flexible attachment means, such as a flexible plastic attachment means. The flexibility allows release of the attachment means from the holding features of the mounting frame in order to remove the protection cover and to provide access to the optical cavity. Such a protection cover can be used multiple times.

In an embodiment of the invention the protection cover comprises a metallic portion including said attachment means. The attachment means of such a protection cover may engage directly with the optical cavity, such that the optical cavity serves as a direct reference for the protection cover. In addition the protection cover may comprise a further plastic portion moulded over the metallic portion to provide protection of the metallic portion of the protection cover.

In an embodiment of the invention the protection cover comprises an adhering structure and/or adhering substance for sticking said protection cover to said circuit board. The adhering structure or substance seals the optical cavity from the environment ensuring that the cavity remains substantially isolated from the environment.

In an embodiment of the invention the circuit board comprises at least one connector header arrangement and said protection cover is adapted to fit within said connector header arrangement. In this case the circuit boards can be manufactured with headers, while the optical cavities remain to be protected by the protection cover until the installation of an optical connector. The protection cover preferably comprises a handling grip for manipulating the protection cover, e.g. during installation in the field.

In an embodiment of the invention further the optical cavity is adapted to accommodate a coupling device for coupling an optical connector to said optical conductors and wherein said protection cover is adapted to accommodate said coupling device. Such a coupling device is described in more detail in the non-prepublished Dutch patent application 1021205 (“Optical connector assembly, coupling device and method for aligning such a coupling device and a waveguide structure”) of the applicant.

The invention further relates to a protection cover and to a circuit board of use in an assembly as described above.

The invention will be further illustrated with reference to the attached drawings, which show preferred embodiments according to the invention.

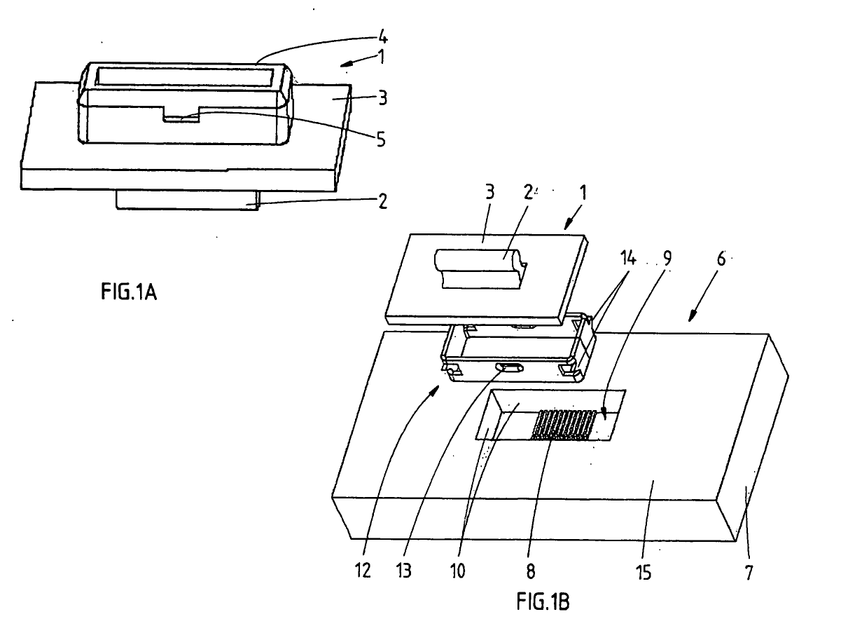

FIGS. 1A and 1B show a protection cover according to a first embodiment of the invention;

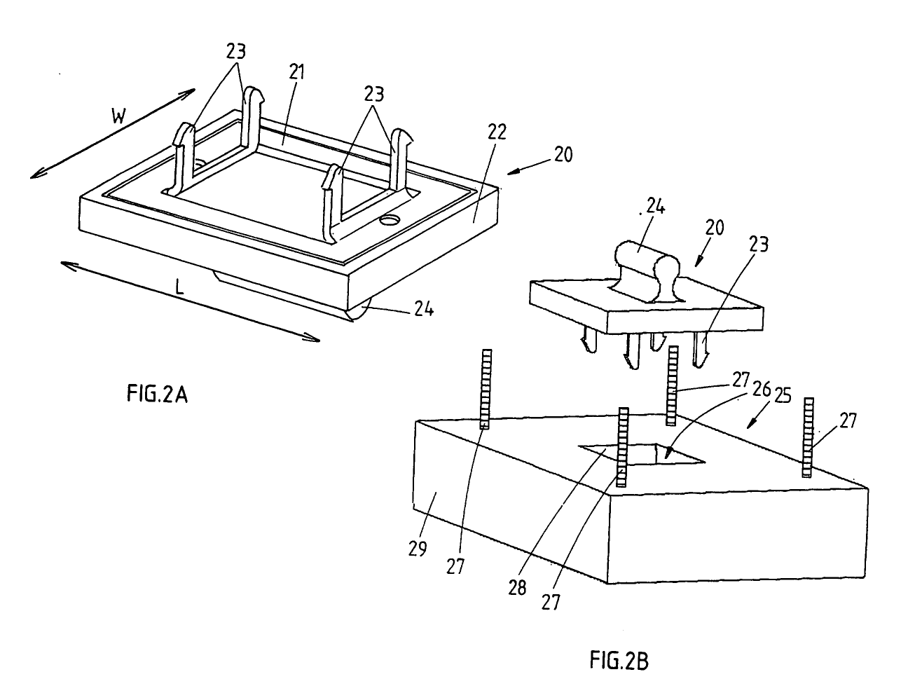

FIGS. 2A and 2B show a protection cover according to a second embodiment of the invention;

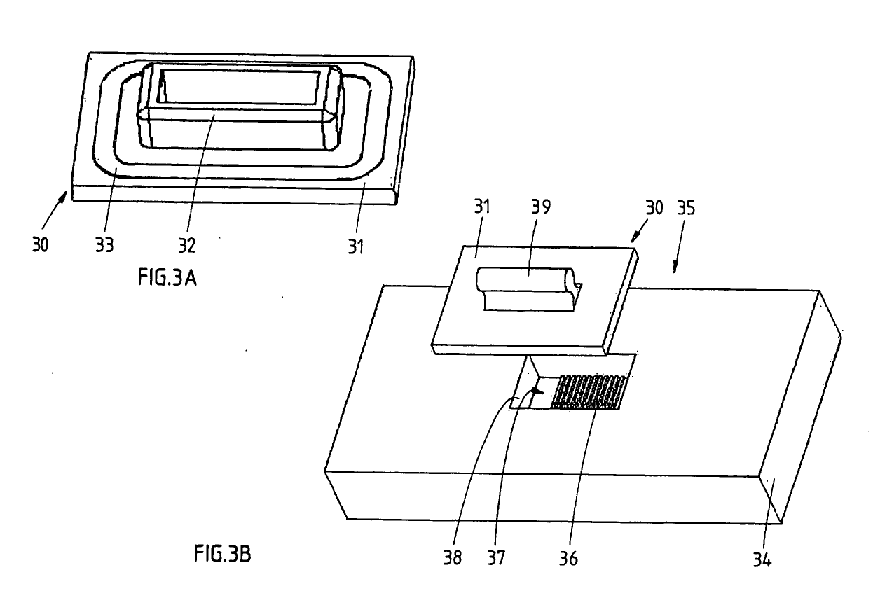

FIGS. 3A and 3B show a protection cover according to a third embodiment of the invention;

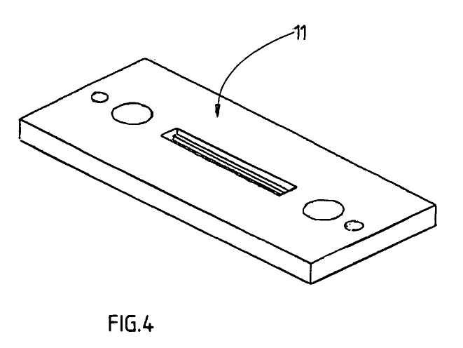

FIG. 4 shows a coupling device for coupling an optical connector to a circuit board with embedded optical conductors.

FIG. 1A shows a protection cover 1 comprising a handling grip 2, a substantially flat cover portion 3 and a protruding portion 4 extending away from the flat cover portion 3. The protruding portion 4 comprises attachment means 5, such as ribs. The ribs 5 preferably are made from plastic. It should be appreciated that the protection cover 1 may entirely be made from plastic as well.

FIG. 1B shows a part of an optical device 6 comprising a circuit board or printed circuit board (PCB) 7 and one or more embedded optical conductors 8. The optical device 6 may be a hybrid optical backplane, as described in more detail in the non-prepublished patent application NL 1021205. The PCB 7 comprises an optical cavity 9 determined by the walls 10 and exposing a part of the embedded optical conductors 8. The optical cavity 9 may accommodate a coupling device 11 (shown in FIG. 4). The optical cavity 9 can be created by several techniques such as laser ablation, chemical etching or mechanical milling.

In FIG. 1B the protection cover 1 can be positioned on the optical device 6 by employing a mounting frame 12. The mounting frame 12 comprises holding features 13, such as indents. Moreover the mounting frame 12 can be fixated in the optical cavity 9 by means of fastening means 14, such as barbs. The barbs 14 cooperate with the walls 10 of the optical cavity 9 to obtain said fixation. The mounting frame 12 is designed to avoid interference with a connector header after placement.

In operation, e.g. before further processing of the PCB 7 or during or after installation in the field, first the mounting frame 12 is positioned in the optical cavity 9, using the walls 10 of the optical cavity 9 as a reference. The barbs 14 assist in remaining the mounting frame 12 in position. Subsequently the protection cover 1 is placed onto the optical device 6 employing e.g. the handling grip 2 such that the plastic ribs 5 of the protruding portion 4 engage with the indents 13 of the mounting frame 12. By the engagement the protection cover 1 securely closes the optical cavity 9 as the flat cover portion 3 abuts against the upper surface 15 of the PCB 7. The optical conductors 8 are thus protected from e.g. environmental influences, such as dust, or mechanical impact. It is noted that alternatively the mounting frame 12 may first be attached to the protection cover 1 before insertion into the optical cavity 9.

Since the ribs 5 are made of plastic the protection cover 1 can be released from the mounting frame 12 by appropriately employing the handling grip 2.

In FIG. 2A a protection cover 20 according to a second embodiment of the invention is displayed. The protection cover 20 comprises a metallic portion 21 and an overmoulded plastic portion 22. The metallic portion 21 is e.g. manufactured by means of a stamping and bending die e.g. stamped or die-cast and comprises attachment means 23, such as latches or grips. The overmoulded portion 22 is defined over the metallic portion 21 and comprises a handling grip 24.

In FIG. 2B it is displayed how the protection cover 20 can be positioned on an optical device 25 comprising an optical cavity 26 and an optical connector header arrangement 27. The dimensions L and W of the protection cover 20 are such that the protection cover 20 fits within the pins of the header arrangement 27. The dimensions of the cover 20 are e.g. in the millimetre range, such as 8×8 mm. The latches 23 use the walls 28 of the optical cavity 26 as a reference for positioning the protection cover 20. The latches 23 cooperate with the walls 28 to attach the protection cover 20 to the optical device 25 and/or the PCB 29. The mounting frame 12 shown in FIG. 1B thus may be omitted in this embodiment.

FIG. 3A shows a protection cover 30 according to a third embodiment of the invention. The protection cover 30 comprises a flat cover portion 31 and a protruding portion 32 extending away from the flat cover portion 31. The protruding portion 32 provides pre-positioning functionality in placing the protection cover 30 to ensure that the optical cavity is sealed at all sides. The flat cover portion 31 further comprises an adhering structure or adhering substance 33 for sticking the protection cover 30 to a circuit board 34, shown in FIG. 3B. The adhering structure or substance 34 is e.g. a rubber edge or a sticky epoxy substance provided along a perimeter of the flat cover portion 31.

FIG. 3B shows an optical device 35 comprising the PCB 34 and embedded optical conductors 36 exposed by an optical cavity 37 as determined by walls 38.

In operation the adhering structure or adhering substance 33 sticks to the PCB 34. As a result the optical cavity 38 is closed and sealed by the protection cover 30, such that the optical conductors 36 are isolated from the environment. Besides protection against dust and/or mechanical impact, such a sealed optical cavity 37 also protects the optical conductors 36 against e.g. moisture. The protection cover 30 can be removed from the PCB 34 by employing the handling grip 39. It is noted that a rubber edge or a sticky epoxy substance 33 may be applied in the first and second embodiment, shown in FIGS. 1A and 2A, as well.

FIG. 4 shows a coupling device 11 that may be positioned within an optical cavity 9,26,37 to provide means for coupling an optical connector (not shown) to the optical conductors 8, 36 as shown in FIGS. 1B and 3B. The coupling device 11 and the optical connectors are described in further detail in the non-prepublished patent application NL 1021205. During installation of the PCB's or hybrid backplane the protection covers may be used to close the optical cavities on the PCB. If an optical connector is to be connected the protection cover may be removed using e.g. the handling grip. After installation the cavities not used for connection may remain closed by the protection covers.

The invention is not restricted to the above described embodiments which can be varied in a number of ways within the scope of the claims. For instance the attachment means of the protection cover may as well engage with additional holes provided in the PCB. Further the coupling device 11 is not necessarily positioned within the optical cavity 9,26,37 but may be placed on the PCB 7,29,34 instead. In such a case the coupling device 11, that e.g. covers the optical cavity, may be used as a reference for alignment of the protection cover 1;20;30, e.g. by employing the edges of the coupling device 11 while accommodating the coupling device 11.

1. Assembly of a protection cover and a circuit board comprising one or more optical conductors characterized in that
said optical conductors are embedded in said circuit board, said circuit board comprising an optical cavity exposing at least a part of said embedded optical conductors and said protection cover is adapted to use said optical cavity as a reference.

2. Assembly according to claim 1, wherein said protection cover comprises attachment means for joining said protection cover and said circuit board at said optical cavity.

3. Assembly according to claim 2, wherein said optical cavity is adapted to accommodate a mounting frame comprising holding features and said attachment means are adapted to engage with said holding features.

4. Assembly according to claim 3, wherein said mounting frame comprises fastening means for fixating said mounting frame within said optical cavity.

5. Assembly according to claim 2, wherein said attachment means comprises a flexible attachment means, such as flexible plastic attachment means.

6. Assembly according to claim 2, wherein said protection cover comprises a metallic portion including said attachment means.

7. Assembly according to claim 1, wherein said protection cover comprises an adhering structure and/or adhering substance for sticking said protection cover to said circuit board.

8. Assembly according to claim 1, wherein said circuit board comprises at least one connector header arrangement and said protection cover is adapted to fit within said connector header arrangement.

9. Assembly according to claim 1, wherein said protection cover further comprises a handling grip.

10. Assembly according to claim 1, wherein said optical cavity is adapted to accommodate a coupling device for coupling an optical connector to said optical conductors and wherein said protection cover is adapted to accommodate said coupling device.

11. Protection cover for use in an assembly according to claim 1.

12. Circuit board for use in an assembly according to claim 1.
